(19) United States
(12) Patent Application Publication
(10) Pub. No.: US 2024/0382961 A1
(43) Pub. Date: Nov. 21, 2024

(54) Transducer Comprising Flexible Buckling Member

(71) Applicant: Baoxiang Shan, Hoboken, NJ (US)

(72) Inventor: Baoxiang Shan, Hoboken, NJ (US)

(21) Appl. No.: 18/693,853

(22) PCT Filed: Sep. 19, 2022
(86) PCT No.: PCT/CN2022/119626

§ 371 Date: Mar. 20, 2024

Related U.S. Application Data
(63) Continuation-in-part of application No. 17/480,132, filed on Sep. 20, 2021, now abandoned.

(30) Foreign Application Priority Data
Sep. 19, 2022 (WO) PCT/CN2022/119626

(51) Int. Cl. B01L 3/00

(52) U.S. Cl. CPC B01L 3/502761; B01L 2200/0647; B01L 2300/123; B01L 2400/0424

(57) ABSTRACT

A buckled member sensing device comprising a flexible sensing member, rigid base member, and compressive element is disclosed in the present invention. When constrained by the rigid base member and the compressive element, the flexible sensing member may change shape to form a buckle. An active element formed from material reactive to specific external stimuli may be disposed of on the buckle of the flexible member. External stimuli that may react with the active element may include chemical, bioagent, heat, air, pressure, radiation, gravity, magnetic, and electromagnetic stimuli. Upon detection of external stimuli, stress may be induced in the active element in the form of surface stress, electromagnetic force, electrostatic force, mechanical force, floating force, fluid pressure, gravity, thermal stress, temperature change, or chemical reaction force. The constant bending strain energy of the buckled flexible sensing member in the disclosed neutrally stable buckled member sensing device allows for high sensitivity to external stimuli.

### RELATED APPLICATIONS

This application claims priority to PCT/CN2022/119626 entitled “Transducer Comprising Flexible Buckling Member” filed by Baoxiang Shan with a Priority Date of 20 Sep. 2021 the contents of all of which are hereby fully incorporated herein by reference.

### FIELD OF THE INVENTION

The present invention relates to transducers comprising a flexible buckled member adapted to convert specifically detected external stimuli into corresponding detectable changes in mechanical, electrical, magnetic, or physical properties of the flexible buckled member.

### BACKGROUND OF THE INVENTION

Sensors have become an invaluable tool for detecting and adapting to events and changes in our physical environment. Sensors have a wide range of applications from simple utility monitors to sophisticated health care devices. Specifically, biosensors capable of detecting and classifying biological subjects or chemical substances have played an outsized role. Biosensing applications include food safety testing, metabolic engineering, and biodefense. In the medical field, biosensors allow scientists to provide for early stage detection of a host of diseases and ailments as well as aid drug discovery and cancer research.

Biosensors generally consist of at least two components including a molecular recognition probe and a physicochemical transducer. A molecular recognition probe selectively interacts with biological materials such as DNA, aptamers, antibodies, ligands, enzymes, microorganisms, cells, and/or tissues. The biological or chemical material to be identified or measured is referred to as the analyte. A physicochemical transducer converts the specific biological interaction into a physical signal based on the select properties of the transducer.

One form of biosensor classification is based on the type of signal transduction mechanism employed. Categories of biosensors include optical, electrochemical and piezoelectric biosensors. While the selectivity of a biosensor is primarily dependent on the properties of the molecular recognition probe, the sensitivity of a biosensor is strongly derived from the physicochemical properties of the transducer. The disclosed invention is a neutrally stable system that can detect the presence of external stimuli with high sensitivity and can be adapted for use in biosensors as well as many other applications in the medical or non-medical fields.

### SUMMARY OF THE INVENTION

A sensing device using a constrained flexible sensing member disposed on a rigid base member is disclosed in the present invention. In preferred embodiments, the inventive sensing device comprises a flexible sensing member adapted to convert specifically detected external stimuli into corresponding detectable changes in mechanical, electrical, magnetic, or physical properties of the flexible buckled member.

In one embodiment of the present invention, the sensing device may include a flexible sensing member disposed on a rigid base member wherein the flexible sensing member is longer than the rigid base member. The flexible sensing member and the rigid base member may both have a first end and a second end. The first end and the second end of the flexible sensing member may be affixed to the respective first end and second end of the rigid base member. A compressive element may provide a normal compressive force on the flexible sensing member towards the rigid base member, thereby deforming the shape of the flexible member that may include a buckle having two inflection points, a buckle apex, and two contact points.

The flexible sensing member may be formed from relatively inextensible but flexible material such as a fabric reinforced silicone, a fabric reinforced polyurethane, a Titanium alloy, a stainless-steel alloy, a copper alloy or an aluminum alloy. The flexible sensing member may also be any soft magnetic metal, metal alloy, or ferromagnetic material. Preferably, the flexible sensing member is formed from a material with high permeability such as steel or silicon steel.

In some embodiments, the flexible sensing member may also be adapted with an active element responsive to external stimulus. The active element may be disposed of on the flexible sensing member as a thin band of material or embedded in the flexible sensing member. Preferably, the active element should be located at an inflection point 140 of the buckle. When exposed to external stimulus, the active element may apply stress to the flexible sensing member. To relieve this stress, the buckle and the buckle apex may be displaced relative to the rigid base member until the localized area surrounding the active element migrates to an area of maximum positive and negative curvatures on the buckle.

An active element may comprise any material or materials capable of responding to an external stimulus or stimuli. The active element may also include materials that respond to chemicals, bio-agents, heat, gravity, buoyant, radiation, electrostatic, magnetic, or electromagnetic forces. Preferably, the active element will respond to the external stimulus to a greater degree than the base material of the flexible member on which the active element is mounted.

A detecting unit may be used to determine any displacement of the active element in response to an external stimulus. The detecting unit may be any device capable of or adapted to detect mechanical, electrical, magnetic, or physical changes to the flexible sensing member or active element. The detecting unit may be selected based on the external stimulus to be detected or measured and the active element material. The cross-section of the inner surface may be circular or elliptical to achieve higher sensitivity.

### BRIEF DESCRIPTION OF THE DRAWINGS

FIG. 1A shows a schematic cross-section of a bistable buckled member sensing device having a buckled flexible member in a stable state according to one embodiment of the present invention.

FIG. 1B shows a schematic cross-section of a bistable buckled member sensing device having a buckled flexible member in a stable state according to one embodiment of the present invention.

FIG. 2A shows a schematic cross-section of a buckled member sensing device having compressive members according to one embodiment of the present invention.

FIG. 2B shows a schematic cross-section of a buckled member sensing device having a compressed buckled flexible member according to one embodiment of the present invention.

FIG. 2C shows a schematic cross-section of a buckled member sensing device having a compressed buckled flexible member according to one embodiment of the present invention.

FIG. 3A shows a schematic cross-section of a buckled member sensing device having a curved compressive member according to one embodiment of the present invention.

FIG. 3B shows a schematic cross-section of an activated buckled member sensing device having a curved compressive member according to one embodiment of the present invention.

FIG. 3C shows a schematic cross-section of an activated buckled member sensing device having a curved compressive member according to one embodiment of the present invention.

FIG. 4A shows a schematic cross-section of a buckled member sensing device having a buckled flexible member compressed under electromagnetic force according to one embodiment of the present invention.

FIG. 4B shows a schematic cross-section of the embodiment in FIG. 4A having a base member formed from a series of discrete members.

FIG. 5 shows a schematic cross-section of an embodiment of buckled member sensing device having a compressive member of complex surface profile according to one embodiment of the present invention.

FIG. 6A shows a schematic cross-section of an embodiment of buckled member sensing device having a buckled flexible member with an initial curvature of the present invention.

FIG. 6B shows a schematic top view of an embodiment of buckled member sensing device having a flexible sensing member of complex geometry.

FIG. 6C shows a schematic cross-section of an embodiment of buckled member sensing device having a buckled flexible laminated member.

FIG. 7A shows a schematic cross-section of an embodiment of buckled member sensing device having a buckled ferrous loop band to be attached and pressed on a continuous magnetic cylindric member (before assembling).

FIG. 7B shows a schematic cross-section of an embodiment of buckled member sensing device having a buckled ferrous loop band to be attached and pressed on a continuous magnetic cylindric member (after assembling).

FIG. 8A shows a schematic perspective view of a buckled band sensing device according to an embodiment of the present invention.

FIG. 8B shows a schematic perspective view of an array of buckled band sensing devices according to an embodiment of the present invention.

FIG. 9 shows a schematic perspective view of a buckled band sensing device according to an embodiment of the present invention.

### DETAILED DESCRIPTION OF THE INVENTION

The preferred embodiments of the present invention will now be described in more detail with reference to the drawings in which identical elements in the various figures are, as far as possible, identified with the same reference numerals. These embodiments are provided by way of explanation of the present invention, which is not, however, intended to be limited thereto. Those of ordinary skill in the art may appreciate upon reading the present specification and viewing the present drawings that various modifications and variations may be made thereto without departing from the spirit of the invention.

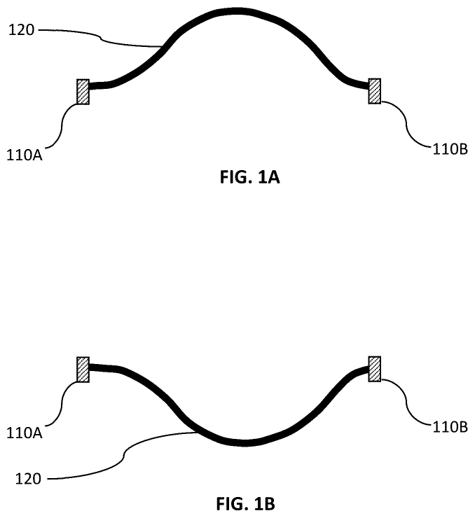

FIGS. 1A and 1B illustrate a schematic cross-section of a transducer in one embodiment of the present invention.

The transducer may be a buckled member sensing device that includes a flexible sensing member 120 of fixed length having a first and second end wherein each end of flexible sensing member 120 is securely affixed to a first and second lateral constraint 110. In preferred embodiments, the length of the flexible sensing member 120 is greater than the distance between the lateral constraints 110. The lateral constraints 110 may be permanently affixed to each other or a surface in a manner that preserves and maintains the fixed distance between the two lateral constraints 110.

In the embodiment disclosed in FIGS. 1A and 1B, the buckled member sensing device exhibits properties of bistability as the system possesses at least two stable states of localized minimum potential energy. The two stable states are shown in FIGS. 1A and 1B. In this embodiment, state transitions can be effected through an application of an activation force to the flexible sensing member 120 wherein the activation force is sufficient to overcome the localized maximum energy between the two stable states.

The flexible sensing member 120 may be formed from relatively inextensible but flexible material such as a fabric reinforced silicone, a fabric reinforced polyurethane, a Titanium alloy, a stainless-steel alloy, a copper alloy or an aluminum alloy. The buckled flexible member may also be any soft magnetic metal, metal alloy, or ferromagnetic material. Preferably, the buckled flexible member is formed from a material with high permeability such as steel or silicon steel.

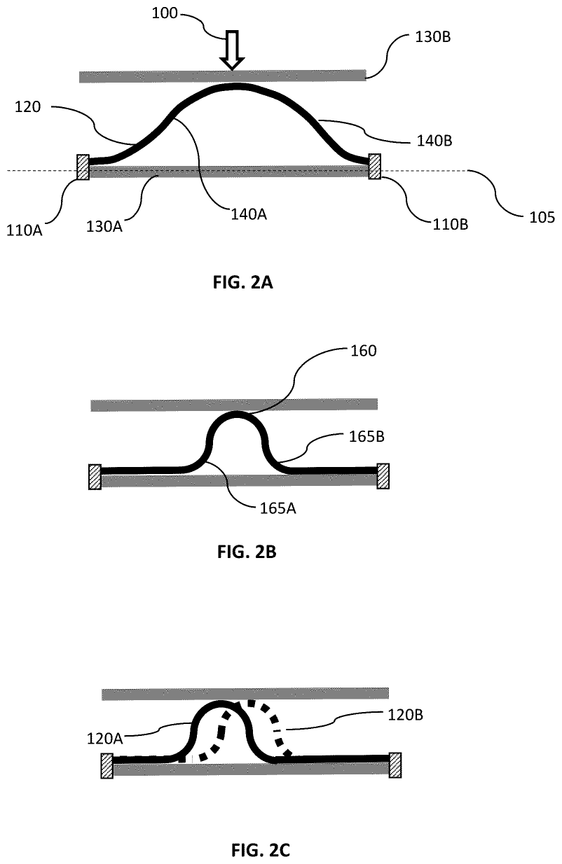

FIGS. 2A, 2B, and 2C illustrate a schematic cross-section of a transducer in another embodiment of the present invention.

The transducer may be a buckled member sensing device that includes a compressive element 100, a rigid base member 130A and a flexible sensing member 120, wherein the length of the flexible sensing member 120 may be greater than the length of the rigid base member 130A.

In some embodiments, the rigid base member 130A may have a first end securely affixed to a first lateral constraint 110A and a second end securely affixed to a second lateral constraint 110B. The flexible sensing member 120 may also have a first end securely affixed to the first lateral constraint 110A and a second end securely affixed to the second lateral constraint 110B. In alternative embodiments, the lateral constraints 110 may be removed and the first end of the rigid base member 130A may be securely fixed directly to the first end of the flexible sensing member 120 and the second end of the rigid base member 130A may be securely fixed to the second end of the flexible sensing member 120. In some embodiments, the flexible sensing member 120 may be constrained such that the first and second ends of the flexible sensing member 120 is in frictional contact with the first and second ends of the rigid base member 130A, respectively.

In preferred embodiments, the length of the flexible sensing member 120 is greater than the length of the rigid base member 130A. When the flexible sensing member 120 and rigid base member 130A are affixed to the same set of lateral constraints 110, the lateral constraining force caused by the lateral constraints 110 on the flexible sensing member 120 may cause the flexible sensing member 120 to deflect away from the rigid base member 130A resulting in a monostable system.

In the embodiment of FIG. 2C, a compressive element is adapted to apply a compressive force on the flexible sensing member 120 causing a buckle to form. The buckle may be defined by a buckle apex 160, a first 140A and second 140B inflection point, and a first and second area of maximum negative curvature relative to the rigid base member 130A. For the purposes of this disclosures, the first and second area of maximum negative curvature is equivalent to the local area surrounding the contact points 165. The compressive element may be employed to ensure frictional contact between portions of the flexible sensing member 120 and the rigid base member 130A. For example, as shown in the embodiments of FIGS. 1A and 1B, the compressive element is a rigid compression member parallel to the rigid base member 130A and configured to exert a compressive force on the flexible sensing member 120 towards the rigid base member 130A, wherein the rigid compression member may be formed from the same material as the rigid base member 130A. As the compressive force increases, the medial distance between the buckle apex 160 and the rigid base member 130A may begin to decrease and a first and second contact region between the flexible sensing member 120 and the rigid base member 130A may begin to widen causing at least one localized section of positive curvature and at least one localized section of negative curvature on the flexible sensing member 120. As shown in FIG. 1D, the base member may be fixed relative to the compressive member 130B as to limit the buckle to one dimensional lateral movement, wherein in the apex 160 of the buckle may shift relative to the lateral axis of the rigid base member 130A.

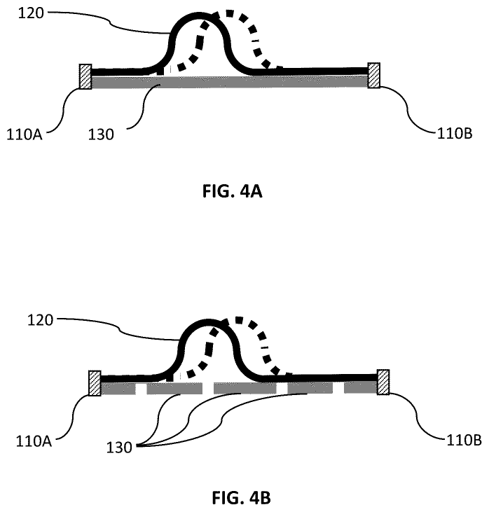

The compressive element may be any component or components that can maintain frictional contact between the flexible sensing member and rigid base member as shown, for example, in FIGS. 2B and 4A. For example, the compressive element may force a buckle to form in the flexible sensing member using self-lateral compression, magnetic force, electromagnetic force, electrostatic force, gravity, floating force, or a combination of forces. As used herein, the compression caused by the compressive element refers to the compression of the flexible sensing member towards the rigid base member, as opposed to the type of resultant force caused by the compressive element.

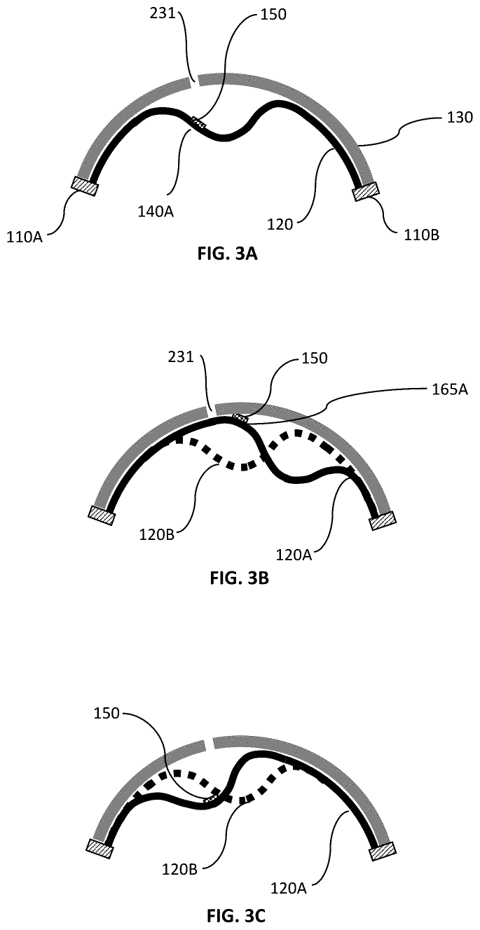

In some embodiments, the rigid base member 130A of the buckled member sensing device may be curved, as shown in FIG. 3A. When constrained within the curve of the rigid base member 130A and compressed by the lateral constraints 110, the strain energy on the flexible sensing member 120 allows the flexible sensing member 120 to largely conform to the shape of the curved rigid base member 130A thus obviating the need for a rigid compressive member 130B. In this embodiment, the strain energy resulting from the deformation of the flexible sensing member 120 acts as the compressive element 100.

The flexible sensing member 120 may also be adapted with an active element 150. The active element 150 may be mounted on one of the inflection points 140 of the buckled flexible member whereby the curvature is zero. The active element 150 may be a thin band of material on or embedded in the buckle flexible member.

External stimulus in the form of aqueous, gaseous, or powdered solutions may be provided through the opening 231 exposing the active element 150 to the external stimulus.

In preferred embodiments, the active element 150 may become stressed when exposed to a solution containing an external stimulus to be detected or measured. The stress induced in the active element 150 may be greater than the stress induced in the base material of the buckled flexible member, both of which may be exposed to external stimulus. The stress induced in the active element 150 may be tensile stress or compressive stress. If the solution does not contain the external stimulus to be detected or measured, stress may not be induced in the active element 150.

An active element 150 may comprise any material or materials capable of responding to an external stimulus or stimuli. The active element 150 may also include materials that respond to chemicals, bio-agents, heat, radiation, or electromagnetic forces. Preferably, the active element 150 will respond to the external stimulus to a greater degree than the base material of the flexible member on which the active element 150 is mounted. For example, the active band may be formed from materials having a coefficient of linear, thermal expansion greater than 5×10−6 m/m/° C. such as, but not limited to, fabric reinforced silicone, fabric reinforced polyurethane, Titanium alloys, stainless steel alloys, copper alloys or aluminum alloys. Particularly suitable materials may include Titanium alloys such as, but not limited to, so called Beta titanium alloys, i.e., titanium alloyed in varying amounts with one or more of molybdenum, vanadium, niobium, tantalum, zirconium, manganese, iron, chromium, cobalt, nickel, and copper. This type of alloy may have a strength/modulus of elasticity ratios almost twice that of 18-8 austenitic stainless steel, allowing for larger elastic deflections in springs, and a reduced force per unit displacement. Suitable alloys may include, but are not limited to, “BETA III” (Ti-11.5 Mo-6.5 Zr-4.6 Sn), Transage 129 (Ti-2Al-11.5V-2Sn-11.3Zr) or Ti-6Al-4V.

In one example, a bioreceptor may bind selectively or specifically to an analyte. When a bioreceptor adapted to interact with a specific analyte or analytes is exposed to said analyte or analytes, the bioreceptor may induce a physical change such as stress in the active element 150.

As shown in FIG. 4A, the compressive element 100 of an exemplary embodiment of the disclosed invention may also be a dielectric layer disposed of between the flexible sensing member 120 and the rigid base member 130A. In some embodiments, the rigid base member 130A may be comprised of multiple discrete sections, as shown in FIG. 4B. Each section may be formed from the same material or different materials. In contrast with the embodiment disclosed in FIG. 2A, the embodiment disclosed in FIG. 4A does not use a compressive member 130B as the compressive element. Rather, the flexible sensing member 120 may be compressed against the rigid base member 130A through magnetic or electromagnetic forces.

For example, the flexible sensing member 120 may be formed from materials with high susceptibility to magnetization such as ferromagnetic irons, steels, ferrous amorphous metals. When the rigid base member 130A is a magnet, the attraction between the magnet and the ferromagnetic material may act as the compressive element 100 and cause the flexible sensing member 120 to compress against the rigid base member 130A forming a buckle. In an alternative embodiment, the compressive element 100 may be a dielectric layer disposed of between the flexible sensing member 120 and the rigid base member 130A, wherein the dielectric layer may be polarized to attract and compress the flexible sensing member 120. In such embodiments, the rigid member acts as a substrate and a dielectric layer may be in contact with the substrate layer extending along one surface and in contact with portions of the buckled flexible member on the opposing surface. In some embodiments, the dielectric layer may be a thin film coating.

The dielectric layer may be formed from any suitable dielectric material including oxides (e.g., silicon oxide) and nitrides (e.g., silicon nitride). In some embodiments, the dielectric layer may be any dielectric material suitable for MEMS fabrication. The substrate layer may be formed from any conducting or semi-conducting material or any substrate material suitable for MEMS fabrication such as silicon. In some embodiments, the substrate layer may be a high resistivity substrate. In further embodiments, the substrate layer may be any material with suitable magnetic or electrostatic properties configured to engage the buckled flexible member. The substrate layer may also be formed with any material with high permeability such as Metglas™.

The compressive elements in the buckled band devices as embodied in FIGS. 2-4 may serve to convert a bistable buckled system with two stable states, as illustrated in FIGS. 1A and 1B, to a neutrally, or nearly neutrally, stable system by limiting the magnitude of out of plane deflections of the flexible sensing member 120. In this neutrally stable system, the potential energy at each state or position of the buckle relative to the rigid base member 130A remains constant. The constant energy may be attributed to the constant bending strain energy of the buckled deflection shape of the flexible sensing member 120. This neutrally stable system allows for detection of the presence of stimuli, including minute quantities of stimuli.

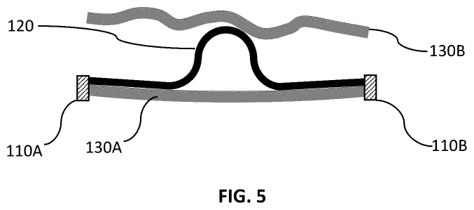

The illustration in FIG. 5 shows an embodiment of the present invention wherein the compressive element is a compressive member 130B. Here, the compressive member 130B has a complex surface profile with peaks and valleys associated with states of local maximum and local minimum potential energy. Incorporating a compressive member 130B with a complex surface profile may allow the transducer to be tuned into a system with any number of stable states.

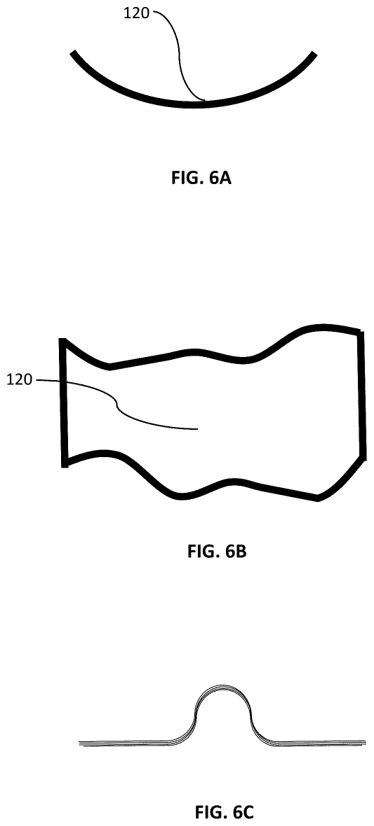

FIGS. 6A-C illustrate means to tune the energy landscape of a bistable buckled transducer system. For example, FIG. 6A shows a flexible sensing member having a negative curvature so to assure the compressed state between the flexible sensing band and the compressive member 130B. The embodiment of FIG. 6B uses geometric shape of the flexible sensing member 120 to achieve performance tuning. The further embodiment of FIG. 6C may use thermal stress or inelastic strain to tune the performance of a laminated flexible member.

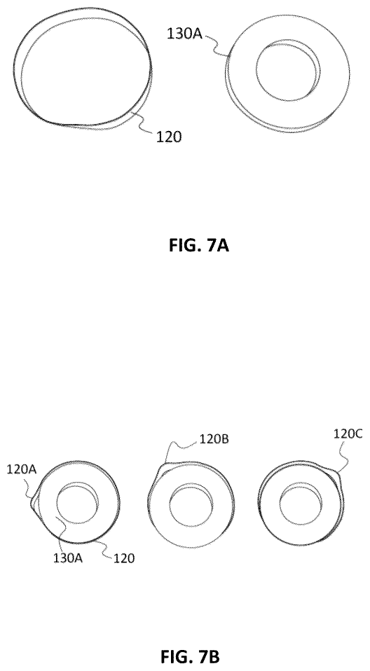

In some embodiments of the present invention, the flexible sensing member 120 may be a continuous band or ribbon of a uniform thickness and a uniform width and having no end point, wherein the width of the band is greater than the thickness. The material composition of the band may be made from the same material as the flexible sensing member. As shown in FIG. 7, the rigid base member may be a continuous magnetic member.

The response of the buckled band sensing device to external stimuli according to one embodiment of the present invention is described herein. The active element 150 may be selected for its ability to elicit a detectable response to specific, identifiable external stimuli. Upon detection of predetermined stimuli, stress may be induced in the active element 150 thereby causing the buckle to move laterally in relation to the rigid base member 130A. For example, as illustrated in FIG. 3B, the stress on the active element 150 may cause the flexible member to change shape from 120A to 120B, effectively shifting the relative location of the buckle laterally along the longitudinal axis 105 of the rigid base member 130A.

In some embodiments, the active element 150 may have a coefficient of thermal expansion greater than that of the flexible sensing member 120. When detecting stimuli, the local area of the active element 150 may expand or contract more quickly than the underlying flexible sensing member 120. In an embodiment wherein an active element 150 is not exposed to external stimuli, the active element 150 may be located at the inflection point 140 of the buckle. To relieve the induced stress, the local area of the active element 150 may migrate to a location of maximum or minimum curvature. In other words, the stressed portion of the flexible member at or near the active element 150 having may effectively migrate to a region of the flexible member where the curvature imparted to the stressed portion more closely matches the curvature of the buckle, such as the local area of the contact points 165 or the buckle apex 160.

Whether the active element 150 moves laterally towards the contact points 165 or the buckle apex 160 may be dependent on factors including whether the active element 150 is mounted on the surface the buckle flexible member facing towards or away from the rigid base member 130A and whether the stress induced in the active element 150 is a tensile stress or a compressive stress. In each configuration, the active element 150 will tend to migrate towards the region of the buckle where the induced stress of the active element 150 can be relieved.

In some embodiments, the active element 150 may be exposed to external stimuli in a liquid, gaseous, or powdered solution. For example, the active element 150 may be submersed or submerged in a liquid solution containing the external stimulus. In another embodiment, the liquid solution containing the external stimulus may be titrated directly on the active element 150 through the entry channel. In yet another embodiment, the active element 150 may be enclosed fully or partially in a container and exposed to a gaseous solution. The active element 150 may be exposed to external stimuli in other fashion or methods and the method of exposure is not limited to the disclosure herein.

An active element 150 may comprise any material or materials capable of responding to an external stimulus or stimuli. The active element 150 may also include materials that respond to chemicals, bio-agents, heat, gravity, buoyant, radiation, electrostatic, magnetic, or electromagnetic forces. Preferably, the active element 150 will respond to the external stimulus to a greater degree than the base material of the flexible member on which the active element 150 is mounted. In some preferred embodiments, for example in a buckled member sensing device adapted to detect changes in gravity, the active element 150 may also be formed from the flexible sensing member.

At least one active element 150 may be positioned on one surface of the buckled flexible member and at least one detecting unit may be positioned on the other surface of the buckled flexible member. In other embodiments, the at least one detecting unit is not mounted or positioned on the flexible sensing member 120. The at least one detecting unit may be positioned outside the buckled member sensing device in some embodiments.

In preferred embodiments, an entry channel extending through the rigid cylindrical enclosure is provided. In other embodiments, the entry channel is a hole extending through the rigid cylindrical enclosure. External stimulus in the form of aqueous, gaseous, or powdered solutions may be provided through the entry channel exposing the active element 150 to the external stimulus. Preferably, the entry channel is located directly above or near the active element 150.

In some embodiments, the active element 150 may be exposed to external stimuli in a liquid, gaseous, or powdered solution. For example, the active element 150 may be submersed or submerged in a liquid solution containing the external stimulus. In another embodiment, the liquid solution containing the external stimulus may be titrated directly on the active element 150 through the entry channel. In yet another embodiment, the active element 150 may be enclosed fully or partially in a container and exposed to a gaseous solution. The active element 150 may be exposed to external stimuli in other fashion or methods and the method of exposure is not limited to the disclosure herein.

A detecting unit may be used to determine any displacement of the active element 150 in response to external stimuli. The detecting unit may be any device capable of or adapted to detect mechanical, electrical, magnetic, or physical changes to the buckled flexible member or active element 150. The detecting unit may be selected based on the external stimulus to be detected or measured and the active element 150 material. The cross-section of the inner surface may be circular or elliptical to achieve higher sensitivity.

For example, the detecting unit may be an electromagnetic detecting coil or piezoelectric element. An electromagnetic detecting coil or piezoelectric element may be utilized to detect static or dynamic pressure in the buckled flexible member or active element 150 before and after exposure to an external stimulus.

In another embodiment, the detecting unit may be a strain gauge device mounted on the buckled flexible member adapted to detect static strain or dynamic strain or other stress induced strain from the buckled flexible member or active element 150 in response to an external stimulus.

In other embodiments, the detecting unit may be proximity switches (e.g., infrared, acoustic, capacitive, inductive) including photo sensors and pressure sensors. In further embodiments, the detecting unit may be an analog inductive device.

In further embodiments, the detecting unit may be a camera or imaging device configured with high optical zoom that allows visual inspection of the displacement of the buckle or buckle apex 160.

FIG. 7A-7B shows a schematic cross-section of an embodiment of buckled member sensing device having a buckled ferrous loop band to be attached and pressed on a continuous magnetic cylindric member.

As shown in FIG. 7A, a loop-band transducer may comprise a rigid base member 130A and a flexibly buckled loop-band member, whereas the flexible member 120 may be longer than the rigid base member 130A in the circumference. In an embodiment, the rigid base member 130A may comprise a continuous cylindrical permanent magnet or a continuous electromagnetic member. In other embodiment, the rigid base member may comprise discrete permanent magnets or electromagnets as shown in FIG. 4B in a circular form. The flexible buckled member 120 may comprise a continuous loop band made of soft magnetic materials or a chain made of soft magnetic materials. When the flexible loop band member 120 is installed on the outside surface of the rigid base member 130A, a part of 120 may be compressed on the surface of 130A by magnetic or electromagnetic forces between 120 and 130A. Therefore, the flexible loop band member 120 may form one or more buckles 120A as shown in FIG. 7B, because the flexible member 120 may be longer than the rigid base member 130A in the circumference.

As shown in FIG. 7B the initial location of buckle of the flexible member 120 may be located at 120A. The different locations of the buckle may represent different states. In this embodiment, the states may be transmitted from one to the other by applying activation force on the flexibly buckled member 120. The activation force may be preferably applied at the inflection point of the buckle 120A. Such an activation force may drive the buckle move from the location 120A to 120B and then to 120C in an undulatory wave way. The flexibly buckled shape of the flexible member 120 may be the same at the different locations like 120A, 120B or 120C, the elastic strain energy of the flexible member 120 may stay constant. Therefore, the activation force to change the state of the buckled member may be very small.

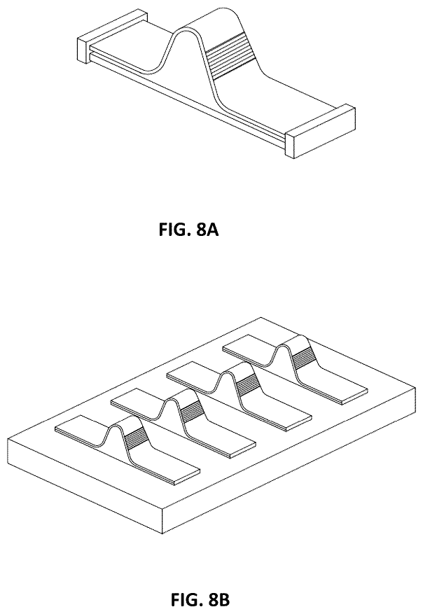

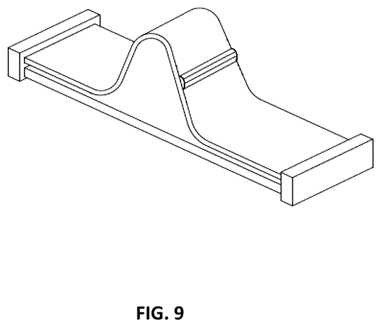

FIG. 8A shows a schematic perspective view of a buckled member sensing device according to one embodiment of this inventor. For example, the Multiple buckled member sensing device can be arranged in series or an array as shown in FIG. 8B. Each individual sensor may have active element 150 adapted to respond to the same external stimulus or different stimulus or different combinations of stimulus. Each individual sensor may be integrated with micro fluid pump to deliver external stimulus to the active element 150s in the buckled member sensing device. In the embodiment of FIG. 8A, an active element may be formed as a thin coating on the flexible sensing member. The active element may comprise materials reactive to chemical or bio-chemical stimuli, thereby allowing the use of the buckled member sensing device as a biosensor. In another embodiment, the active element may comprise materials with a higher coefficient of thermal expansion than that of the flexible sensing member. This embodiment may be used as a temperature sensor. As shown in FIG. 9, in some embodiments, the active element is a dead weight disposed on the flexible sensing member at the inflection point of the buckle, thereby allowing the sensing device to be used as an accelerometer or inertial sensor.

The buckled member sensing device may be fabricated in a variety of dimensions, such as, microscale or nanoscale fabrication and claimed subject matter is not limited in this regard.

The term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

I claim:

1. A transducer comprising:
a rigid base member having a first surface;
a flexible member having a second surface;
wherein, the first surface of the rigid base member is in frictional contact with the second surface of the flexible member to form a buckle having a buckle apex;
wherein, stress induced in at least one region of the flexible member displaces the buckle apex relative to the rigid base member.

2. The transducer of claim 1, further comprising one or more compressive elements suitable to force contact between the first surface and second surface.

3. The transducer of claim 1, wherein the rigid base member is curved.

4. The transducer of claim 1, wherein the rigid base member comprises one or more segments.

5. The transducer of claim 1, wherein the rigid base member comprises a dielectric layer and a substrate layer, wherein the dielectric layer is in contact with the second surface of the flexible member.

6. The transducer of claim 1, wherein the rigid base member is a magnet.

7. The transducer of claim 2, wherein the one or more compressive elements is a rigid member.

8. The transducer of claim 2, wherein the one or more compressive elements is a rigid base member curved to force contact between the first surface and second surface through lateral compression.

9. The transducer of claim 2, wherein the one or more compressive elements is a flexible member formed from ferromagnetic material, wherein the flexible member is attracted to the rigid base member through magnetic or electromagnetic force.

10. The transducer of claim 2, wherein the one or more compressive elements forces contact between the first surface and second surface through either self-lateral compression, magnetic force, electromagnetic force, electrostatic force, gravity or floating force or a combination thereof.

11. The transducer of claim 2, wherein the one or more compressive elements are located on one of the flexible member, the rigid base member, or a combination thereof.

12. The transducer of claim 2, wherein the one or more compressive elements are embedded in one of the flexible member, the rigid base member, or a combination thereof.

13. The transducer of claim 1, further comprising an activating element configured to induce stress in at least one region of the flexible member.

14. The transducer of claim 13, wherein the activating element is disposed on the flexible member.

15. The transducer of claim 14, wherein the activating element is located at or near an inflection point of the buckle.

16. The transducer of claim 14, wherein the activating element is formed from material having a coefficient of thermal expansion greater than the flexible member.

17. The transducer of claim 13, wherein the activating element is configured to induce one of surface stress, electromagnetic force, electrostatic force, mechanical force, floating force, fluid pressure, gravity, thermal stress, temperature change, or chemical reaction force, or a combination thereof.

18. The transducer of claim 13, wherein the activating element induces stress in response to an external stimulus.

19. The transducer of claim 13, wherein the external stimulus is one of chemical, heat, light, radiation, gravity, movement, electric, magnetic, or pressure, or a combination there.
